(19) United States
(12) Patent Application Publication
(10) Pub. No.: US 2020/0175536 A1
(43) Pub. Date: Jun. 4, 2020

(54) METHOD FOR OPERATING MULTILEVEL STRUCTURE SALES SYSTEM

(71) Applicant: Daiken Biomedical Co., Ltd., TAIPEI CITY (TW)

(72) Inventor: Chia-Ming Chang, Taipei City (TW)

(21) Appl. No.: 16/207,347

(22) Filed: Dec. 3, 2018

(51) Int. Cl. G06Q 30/02

(52) U.S. Cl. CPC G06Q 30/0214

(57) ABSTRACT

Disclosed is a method for operating a multilevel structure sales system. The sales system includes a plurality of nodes. A server of the system runs a software program to process relationships among the nodes and process credits thereof. The server manages link relationships among the nodes. The number of nodes in a next level of a node is limited to a link limit. The server also manages credits earned by a node from the profit gained by its lower level nodes within a level limit. When one of the nodes of the sales system generates profit, the credits earned by its upper level nodes within the level limit are calculated. The upper level node obtains credits from the profit gained by its lower level nodes if the upper level node is eligible to obtain the credits.

### FIELD OF THE DISCLOSURE

The specification relates to a sales system, and in particular, to a method for operating a multilevel structure sales system which is set with a level limit and a link limit.

### BACKGROUND OF THE DISCLOSURE

In contrast to direct selling of goods in conventional stores or shopping malls, several multilevel marketing plans for selling goods exist. In a multilevel marketing system, participating members directly sell goods to customers and recruit others to join in as their downlines based on a profit-sharing mechanism. In this way, particular goods can be successfully and effectively sold to consumers, and the consumers also become prospective members.

Multilevel marketing usually proposes a sales bonus system, through which participating members profit by selling goods. However, many multilevel marketing plans set some profit-sharing rules to ensure that members in upper levels gain a large amount of bonus and to urge the other members to work harder on sales and recruitment in order to receive a stable profit. Moreover, the existing bonus system of multilevel marketing is vague or sets restrictions to make it difficult for newcomers to profit.

For example, some multilevel marketing systems require members to be associated, and thus the profit gained by one member depends on the profit of the other, which results in unfairness or overstress on sales.

### SUMMARY OF THE DISCLOSURE

In response to the above-referenced technical inadequacies, the present disclosure provides a method for operating multilevel structure sales system. Compared with the existing several multilevel marketing plans that are unfair and vague to members, the disclosure proposes a method for operating a multilevel structure sales system which has a profit-sharing downline limit and a level limit. Due to its explicit architecture, the multilevel structure of the whole sales system is apparent to the participating members. Therefore, the profit made by one member contributes to the earnings of members in upper levels in a fair and reasonable way. The disclosure further relates to a flow of processing credits gained from profit in the system.

In an embodiment, according to the proposed method for operating a multilevel structure sales system, when one of the nodes of the sales system generates profit, a software program is run to judge whether all the upper level nodes linked to the profiting node within a level limit are eligible to obtain credits. As a result, any eligible upper level node linked to the profiting node within the level limit can obtain the credits according to a ratio; on the contrary, any ineligible upper level node of the profiting node cannot obtain the credits, and the failure of this ineligible node does not affect the eligibility of the other nodes to obtain the credits.

Further, in the multilevel structure sales system, the number of nodes in a next level of a node is limited to a link limit; and each node earns the credits from the profit gained by its lower level nodes within the level limit.

In an embodiment, the method for operating a multilevel structure sales system can be performed in a server, and the server utilizes one or more processors to run a credit processing program of the sales system. The program includes starting calculation of the credits earned by the upper level nodes linked to the profiting node within the level limit.

Further, each node in the multilevel structure sales system is a sales node that sells goods in an online store or a physical store. Moreover, the multilevel structure sales system presents a cloud platform, on which terminal members can sell goods. The cloud platform adopts distributor software as a portal of the sales node.

The techniques and methods adopted by the present invention to achieve the set objective and the efficacies thereof can be further understood with reference to detailed descriptions and drawings of the present invention below. Accordingly, a better understanding of the objective, characteristics, and features of the present invention can be achieved. However, the accompanying drawings are merely provided for reference and demonstration, instead of limiting the present invention.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is an architectural diagram illustrating an embodiment of a multilevel structure sales system;

FIG. 2 is a block diagram illustrating an embodiment of the multilevel structure sales system;

FIG. 3 is a flowchart illustrating an embodiment of a method for establishing the multilevel structure sales system;

FIG. 4A to FIG. 4I are schematic diagrams illustrating an embodiment of establishing nodes in the multilevel structure sales system;

FIG. 5 is a schematic diagram illustrating an embodiment of the nodes that form the multilevel structure sales system;

FIG. 6 is a schematic diagram illustrating an embodiment of basic link relationships among the nodes in the multilevel structure sales system;

FIG. 7 is a flowchart illustrating an embodiment of a method for operating a multilevel structure sales system;

FIG. 8 is a schematic diagram illustrating a picture of sales software run on a terminal device in the multilevel structure sales system;

FIG. 9 is another schematic diagram illustrating a picture of the sales software run on the terminal device in the multilevel structure sales system;

FIG. 10 is an architectural diagram illustrating another embodiment of the multilevel structure sales system; and

FIG. 11 is an architectural diagram illustrating still another embodiment of the multilevel structure sales system.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The specification discloses a method for operating a multilevel structure sales system, including how to run a program of processing credits earned from profit in the sales system. The multilevel structure sales system is set with a plurality of nodes distributed in levels. Each node may be a sales node established by a member of the sales system. The sales node may be a physical store or a virtual store. One of the features of the proposed multilevel structure sales system is that, the number of nodes (horizontally linked) in a next level of a node is limited to a link limit, instead of taking all the members recruited by one member as direct downlines of the member. Although the upper level member may earn more from unlimited downlines, the profit of the downlines cannot be ensured. The multilevel structure sales system sets that each node can share profit gained by the lower level nodes (vertically linked) within a level limit. The limited number of levels from which the profit can be shared by each node can ensure sustainable operation of the system. The participating member can rapidly recruit downlines based on the level limit and the link limit. Therefore, stable operation of the whole multilevel structure sales system is ensured, and a more explicit profit-sharing mechanism is provided.

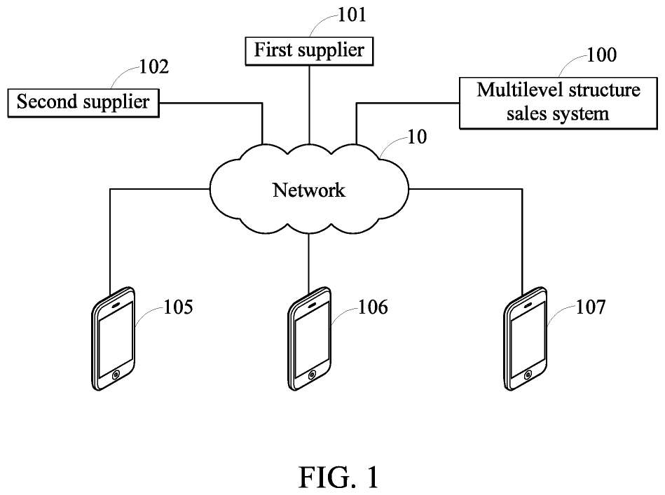

The multilevel structure sales system and the related method will be described by using the following embodiments. FIG. 1 is an architectural diagram illustrating an embodiment of a multilevel structure sales system. The multilevel structure sales system 100 shown in FIG. 1 can present a cloud platform. The whole system is configured via a network 10, and is linked to a first supplier 101 and a second supplier 102 of goods. Members 105, 106, and 107 participate in the multilevel structure sales system 100 via the network 10.

For example, after participating in the multilevel structure sales system 100 and becoming sales nodes of the system, the members 105, 106, and 107 can run an online store with goods and related software programs provided by the multilevel structure sales system 100. The members sell goods provided by the first supplier 101 and the second supplier 102 in the online store. Further, the members 105, 106, and 107 can still run a physical store with goods provided by the sales system.

In this way, when a profit-sharing architecture is established by members of the multilevel structure sales system 100, the sales node formed by each member becomes a profiting interface. When one of the nodes generates profit, the multilevel structure sales system 100 adopts a server to calculate the credits earned by upper level nodes linked to the node. The credits may be regarded as one form of profit share, and have a conversion ratio with physical currency.

In an example, the multilevel structure sales system 100 provides a sales consultant for each member (105, 106, 107), and the sales consultant is assigned when the member is registered. For instance, if a member joins in the sales system after consuming in a franchised chain-store (one of the sales nodes) of a member A (the system will trace the source node of each transaction), the member A becomes a sales consultant. If a consumer is directly registered on and consumes on an official website (non-sales node) provided by the multilevel structure sales system 100, the multilevel structure sales system 100 calculates and assigns an appropriate franchised chain-store owner (a sales node) as a sales consultant to the new member. The sales consultant (for example, the franchised chain-store owner) can profit from the consumption of the members.

Generally, if one consumer intends to become a sales node of the multilevel structure sales system 100, the system can provide rules of becoming a qualified sales node, which involve, for example, membership fees, consumption threshold, and recruitment. Once a consumer becomes a member of the multilevel structure sales system 100, the consumer not only becomes a lower level node of his/her sales consultant and shares profit with upper level nodes (including the sales consultant), but also can have lower level nodes from which profit is shared within a short time since the multilevel structure sales system 100 sets a link limit for each level.

However, to ensure sustainable operation of the multilevel structure sales system 100, whether a member is eligible to share profit is set by the system. Only eligible members (periodically checked) can share the profit gained by the lower level nodes according to a ratio (the profit share may be indicated in the form of credits).

The server of the multilevel structure sales system 100 runs a software program to trace the sales node of each transaction (for example, according to a cookie or user account). After joining in the membership, the consumer establishes a link relationship with the sales node and becomes one of its lower level nodes. The server also needs to manage the cash flow and material flow (if necessary) of each sales node. When a consumer orders and pays successfully at a specific sales node, the multilevel structure sales system 100 creates an order and informs the first supplier 101 and the second supplier 102 of delivery according to the order. The member can earn retail profit from goods selling and gain sales credits after becoming a sales node.

Further, a member of the system can recommend people who are interested to join in the multilevel structure sales system 100, and become an upper level node of the new members (nodes). On the contrary, if a member joins in the multilevel structure sales system 100 via a webpage interface, for lacking of a direct sales node or recruiter, the multilevel structure sales system 100 calculates and assigns an upper level node to the node formed by the new member, and the new node becomes a lower level node of the assigned node.

It should be noted that, a member or a node of the multilevel structure sales system 100 may be an individual or an enterprise, a company, a store and the like and becomes a sales node to participate in profit sharing and goods selling.

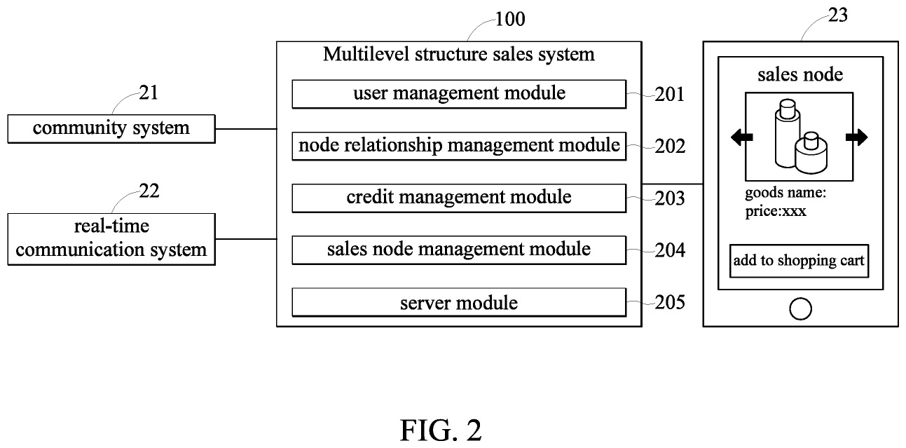

FIG. 2 is a block diagram illustrating an embodiment of the multilevel structure sales system. FIG. 2 shows several main functional modules configured by software and hardware in the server of the multilevel structure sales system 100. The main functional modules include a user management module 201, a node relationship management module 202, a credit management module 203, a sales node management module 204, and a server module 205.

In addition to user management, node management, and server functions, a major module is the node relationship management module 202, which is configured to manage link relationships among the nodes in the multilevel structure sales system 100 and record the link relationships among the nodes (IDs thereof) by means of database indexing. The link relationships include link relationships between each node and its next level node (or nodes) and link relationships between each node and its upper level node (only one) in the multilevel structure sales system 100. Particularly, the number of nodes in a next level of a node is limited to a link limit, and the number of nodes in each level is limited by the structure; however, the profit shared by each node can still be ensured due to the presence of multiple levels (limited by a level limit).

Another major module of the multilevel structure sales system 100 is the credit management module 203, which is configured to run a credit processing program according to the link relationships among the nodes in the system. The credit processing program is an algorithm for sharing profit earned by a node through sales. Each node in the multilevel structure sales system 100 can earn the credits from the profit gained by one or more of its lower level nodes within a level limit.

In an embodiment, the server of the multilevel structure sales system 100 further includes the user management module 201, which is configured to manage members of the multilevel structure sales system 100, including basic information, credit management, sales information and the like of each member as well as one or more nodes established by the member. That is, each member can establish a plurality of nodes, and each node can earn credits through the established link relationships between upper and lower levels as long as it is eligible to obtain the credits.

The multilevel structure sales system 100 is provided with the sales node management module 204, which is configured to manage operation of each node. Take a sales node 23 as an example. The sales node 23 may be an online store or a physical store that sells goods, and helps to link a consumer to the multilevel structure sales system 100. The node can present goods information and a transaction process via a user interface provided by the server module 205. The sales node management module 204 processes requirements of cash flow and material flow proposed by each node via the user interface, and manages the profit gained by each node as well as the credits earned by each node from the profit of its lower level nodes.

Further, the multilevel structure sales system 100 can be linked to a community system 21, or the multilevel structure sales system 100 and the community system 21 can be implemented via a cloud platform at the same time, such that the members of the multilevel structure sales system 100 can establish a community relationship and share information through the community system 21.

For example, there may be professionals, like doctors and pharmacists, among the members of the multilevel structure sales system 100. If the goods provided by the multilevel structure sales system 100 belong to healthy food, these professional members can be invited to make a speech through the community system 21, for example, to deliver health-related information by live broadcast or by leaving a message in the group.

Moreover, the multilevel structure sales system 100 may also be linked to a communication system, such that the members of the multilevel structure sales system 100 transfer information through the communication system in the form of characters, pictures, or audio and video content. The communication system is, for example, a real-time communication system 22 through which the members can communicate in real time.

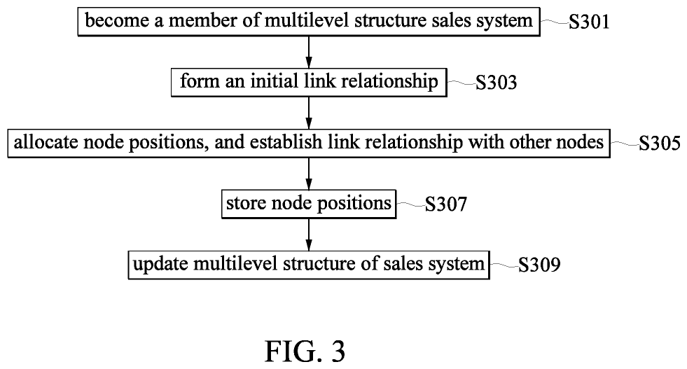

FIG. 3 is a flowchart illustrating an embodiment of a method for establishing the multilevel structure sales system. Firstly, in Step S301, a consumer becomes a member of the multilevel structure sales system through consumption or in other ways. In this case, in Step S303, the system allocates an ID to the new member through a software program, and forms an initial link relationship according to rules (for example, a link limit and a level limit), such that a link relationship is established between the new member and the sales node through which the new member is recruited.

This link relationship influences the position of the new member in the system. In Step S305, the system allocates node positions through the software program, to establish link relationships with the other nodes. In Step S307, the server of the system stores the node positions in a database. In Step S309, the multilevel structure of the whole sales system is updated.

According to the method for establishing the multilevel structure sales system, the node positions are allocated in Step S305. Related rules of the multilevel structure sales system are set. For example, each sales node may develop left, middle, and right lower level nodes, which is called a three-track approach. When the three lower level nodes are established, the newly added fourth lower level node will be automatically placed by the system on the lower left side of the left lower level node.

The newly added lower level node may be recruited by another member. However, regardless of being recommended by one sales node or the other, the new member is placed by the system on a vacancy in a generation closest to the sales node among its lower level nodes. In this way, the new node becomes one of the lower level nodes of a member (recruiter), and a link relationship is established between the member and the closest node to the member. When the closest level has a plurality of vacancies, all the left vacancies in the level are filled from left to right first, then all the middle vacancies are filled from left to right, and finally all the right vacancies are filled from left to right.

The method for establishing the multilevel structure sales system may be performed in a server, and the server may present a cloud platform. The server runs a software program to add a new member and allocate an ID and a node position to the new member. Thus, the new member becomes a member of the multilevel structure sales system, and a new node of the system is established. The server runs the software program to establish a link relationship between this new node and a node in the upper level, such that the new node becomes one of the nodes in a next level of the upper level node within the link limit.

The new node and its upper level node are each provided with an ID. Then, the server records the link relationship between the new node and its upper level node in a database or by other means, and updates the multilevel structure of the sales system.

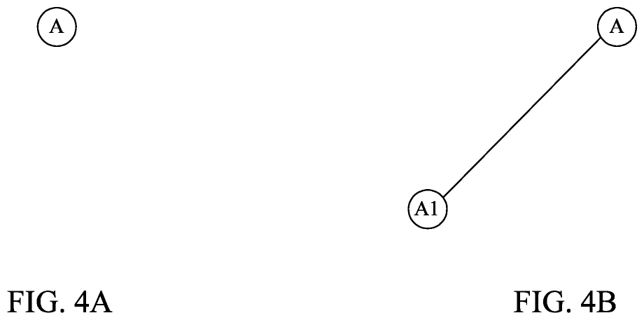

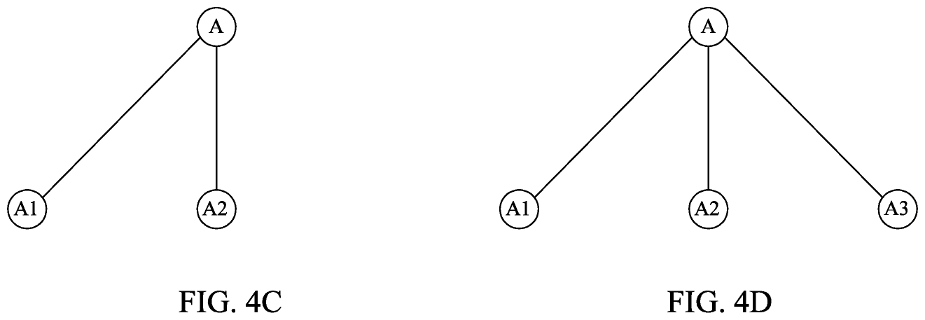

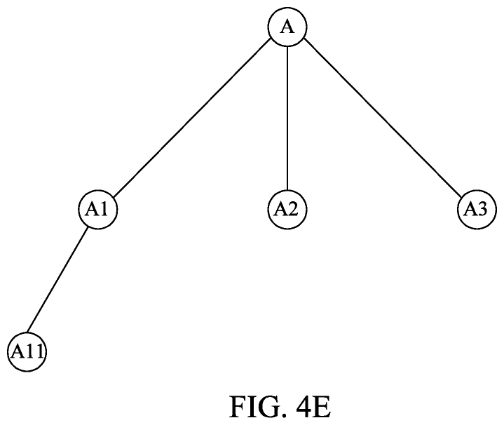

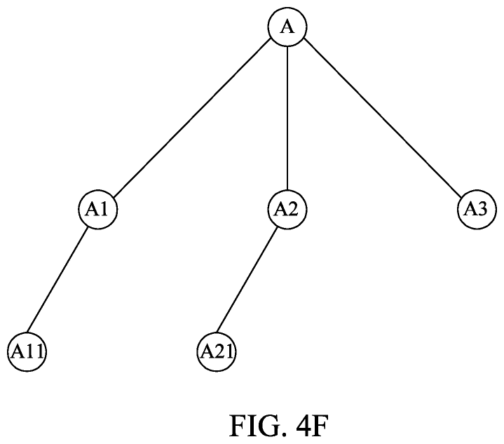

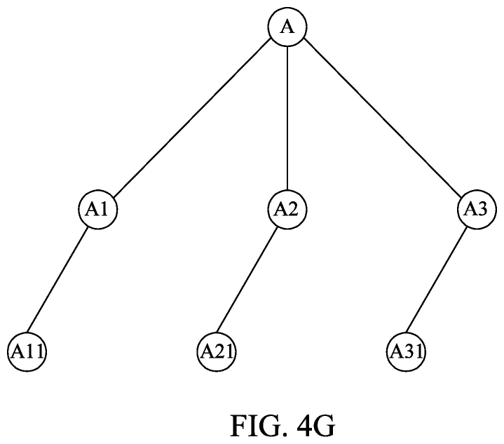

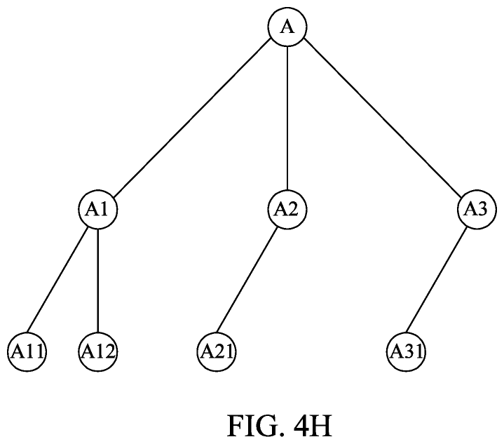

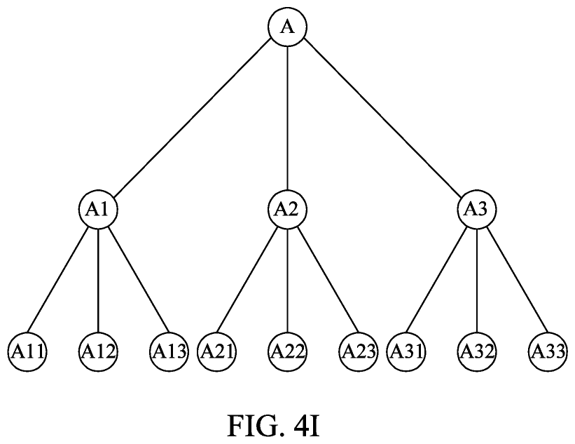

A related embodiment is described with reference to FIG. 4A to FIG. 4I which are schematic diagrams illustrating the establishment of nodes in the multilevel structure sales system. The sequence of establishing the nodes is shown as an example, and can be modified according to circumstances and calculation methods in practice.

As shown in FIG. 4A, the architecture of the multilevel structure sales system starts from a first level node A. Then, a new node may join in voluntarily or through a particular sales node (for example, the first level node A) to form a second level node A 1 linked to the first level node A as shown in FIG. 4B. The link limit (horizontal relationship) is 3 in this example.

Further, as shown in FIG. 4C, a next new node becomes a second level node A2 of the first level node A. Therefore, two nodes, namely, A1 and A2 exist in the second level. According to the link limit of the multilevel structure sales system, FIG. 4D shows that the first level node A has the second level nodes A1, A2, A3. As shown in FIG. 4E, one more new node will be placed in a third level. That is, the first level node A has the second level nodes A1, A2, A3, and one more new node becomes a next level node of the node Al and is shown as a third level node A11.

It should be noted that, the new node A11 may join in through the first level node A as a sales node or by recruitment. Due to the link limit of the system, the new node A11 is arranged at a position closest to the node A, and is thus assigned to a lower level of the second level node A1. Similarly, the new node All may also join in the system through the second level node A1 or by recruitment, and is arranged in a next level of A1 according to the rules.

As shown in FIG. 4F, the first level node A has the second level nodes A1, A2, A3, the second level node A1 is linked to the third level node A11, and one more new node becomes a third level node A21 subordinate to the second level node A2. The new node A21 is assigned in a similar way as A11.

As shown in FIG. 4G according to the same calculation rules, one more new node becomes a third level node A31 subordinate to the second level node A3.

As shown in FIG. 4H, according to the calculation rules, following A31, one more new node is linked to the second level node A1 and becomes a third level node A12 shown in FIG. 4H.

The third level can be filled with new nodes which are sequentially arranged according to the above embodiment. As shown in FIG. 4I, the first level node A has the second level nodes A1, A2, A3, the second level node A1 has the third level nodes A11, A2, A13, the second level node A2 has the third level nodes A21, A22, A23, and the second level node A3 has the third level nodes A31, A32, A33.

In the above schematic diagrams of establishing the sales system, centered with the first level node A, the left, middle, and right lower level nodes closest to the node A are referred to as the first generation; and in the same way, the three lower level nodes in the first generation each develop three lower level nodes, and the nine sales nodes are referred to as the second generation.

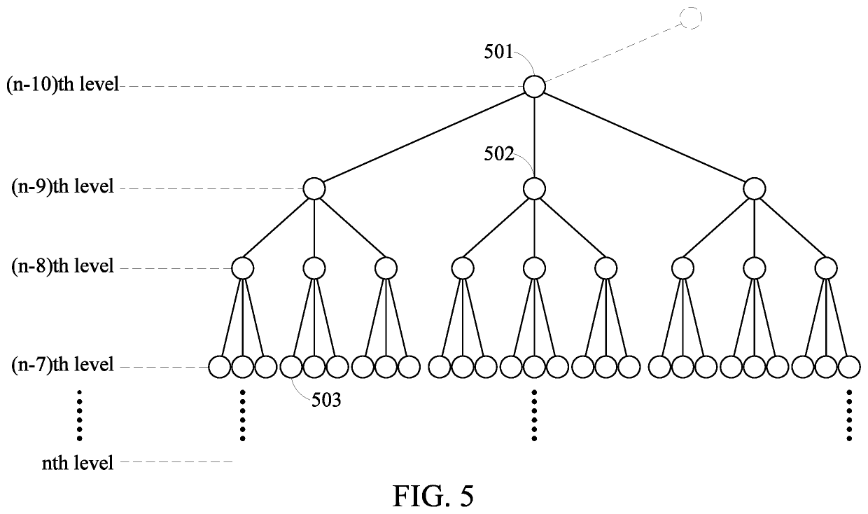

The vertical structure of the multilevel structure sales system may be shown in FIG. 5, in which the number of the profit-sharing levels is limited to a level limit, to prevent profit-sharing errors and ensure sustainable operation of the system. In this example, the link limit is 3 and the level limit is 10 in the multilevel structure sales system.

In FIG. 5, the architecture develops from a first node 501 in the (n−10)th level (a first generation, where the first node 501 may still be a lower level node of another node). In the (n−9)th level, three next level nodes (a second generation) including a second node 502 are developed. In the (n−8)th level, each of the upper level nodes develops three nodes, and altogether nine nodes (a third generation) are obtained. Then, in the (n−7)th level, 27 nodes including a third node 503 are shown.

Since the level limit determines the number of levels from which the profit can be shared by the first node 501 in the first generation, in this example, the first node 501 can obtain the credits from the profit gained by all the nodes in the nth level. In this example, the level limit is 10.

According to the embodiment, each node may be an ordinary member, and the system enables each member to establish a dedicated sales node through which the member and others can purchase goods from the system. In this way, profit is generated at this node and based on that, the upper level node earns credits (profit).

How each node in the multilevel structure sales system obtains the credits from the profit gained by its lower level nodes is illustrated below with an example, which is merely used to describe the profit-sharing operation of the sales system instead of limiting the scope of the invention.

Each node in the multilevel structure sales system is run as a sales node, and can establish its own lower level nodes under the rules (including the level limit and the link limit). A new node can be linked at a node position closest to the sales node, and reference can be made to the example shown in FIG. 4A to FIG. 4I or in FIG. 5.

When the level limit is 10, each sales node establishes its own lower level nodes, and obtains 5% (profit-sharing ratio) of the profit gained per month by the lower level sales nodes within 10 generations as its credits which are bonus in practice. The node cannot earn credits from the profit gained by nodes of the lower levels beyond 10 generations. Limited to 10 generations or to a certain number, the level limit ensures that the profit shared by a node may not be too high and also ensures sustainable operation of the multilevel structure sales system within certain profit.

It should be noted that, the system sets a condition for each node to share the profit gained by its lower level nodes, for example, the node needs to achieve a certain sales volume or needs to recruit new members.

Further, one member can run more than one sales node, and each node needs to satisfy the condition set by the system in order to share profit. Another sales node of the member can also become its lower level node, and the lower level node can still earn credits from the profit gained by nodes in lower levels within the level limit.

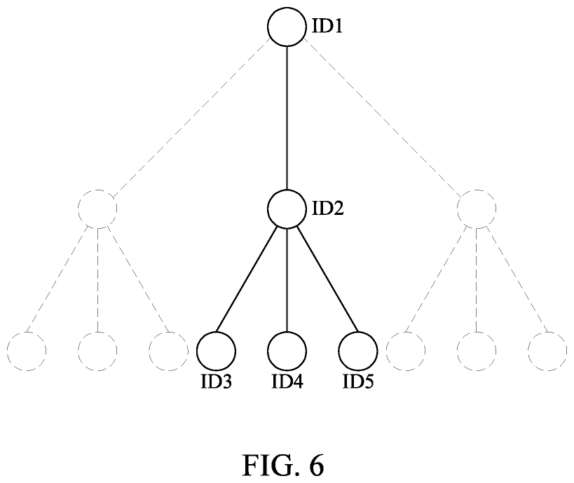

Next, as shown in FIG. 6, the multilevel structure sales system establishes link relationships of nodes according to the ID of each node, and in this example, the link limit is 3.

In FIG. 6, a first node ID1 in a first generation is linked to three lower level nodes in a second generation including a second node ID2. The second node ID2 is linked to lower level nodes in a third generation including a third node ID3, a fourth node ID4, and a fifth node ID5.

The multilevel structure sales system allocates an ID to a new node. The ID is recorded in the database of the system and is further used as a basis for indexing. The multilevel structure sales system calculates credits earned by upper level nodes based on the profit of a node according to the link relationships.

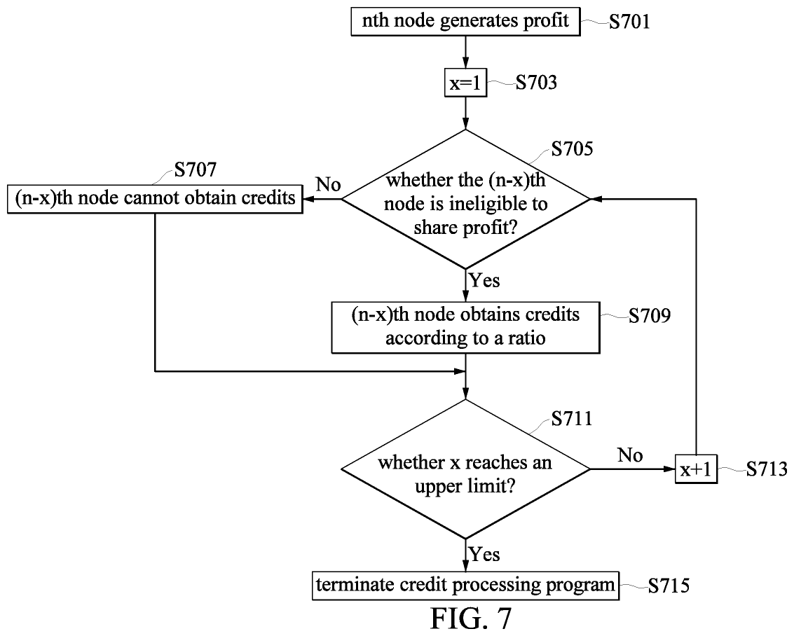

FIG. 7 is a flowchart of the method for operating a multilevel structure sales system, which mainly describes a flowchart illustrating an embodiment of a method for earning credits by each node under the architecture of the sales system. This flow is merely used to describe that the server of the system utilizes one or more processors to run a credit processing program of the multilevel structure sales system. When one of the nodes of the sales system generates profit, the credits earned by its upper level nodes within the level limit are calculated. The variable is merely used for explanation, instead of limiting the algorithm.

When the nth node generates profit (Step S701), in the profit-sharing calculation process, a variable x may be set first and its initial value is 1 (Step S703), to limit the number of levels participating in profit sharing. Next, the credit processing program is used to judge whether any of the upper level nodes linked to the profiting node within the level limit is eligible to obtain the credits. In this example, the credit processing program is used to judge whether the (n−x)th node (for example, n−1) reaches the profit-sharing threshold? (Step S705). It is judged whether any upper level node of the profiting node reaches the threshold of obtaining the credits (profit-sharing), and if not, it indicates that the (n−x)th node is ineligible to share profit and therefore the (n−x)th node cannot obtain the credits (Step S707); on the contrary, if the (n−x)th node is eligible to share profit (if yes), the (n−x)th node obtains the credits according to a ratio (Step S709).

In this repetitive flow, Step S711 is performed to determine whether x reaches an upper limit? The upper limit is the level limit. If not, it indicates that x has not reached the upper limit, and x is added by 1, that is, x+1 (Step S713). The process then returns to Step S705. In this repetitive process, each time x is added by 1 till it reaches the upper limit (if yes), and then the credit processing program is terminated (Step S715).

Under this rule, the upper level node obtains the credits calculated from the profit gained by the profiting node if the upper level node is eligible to obtain the credits; and the upper level node cannot obtain the credits calculated from the profit gained by the profiting node if the upper level node is ineligible to obtain the credits; however, the presence of any ineligible node does not affect the eligibility of the other upper level nodes to obtain the credits.

After that, the server of the sales system records in the database the profit gained by any node each time, the credits earned by each upper level node linked to the node within the level limit, and the credits earned by each node from one or more of its lower level nodes within the link limit.

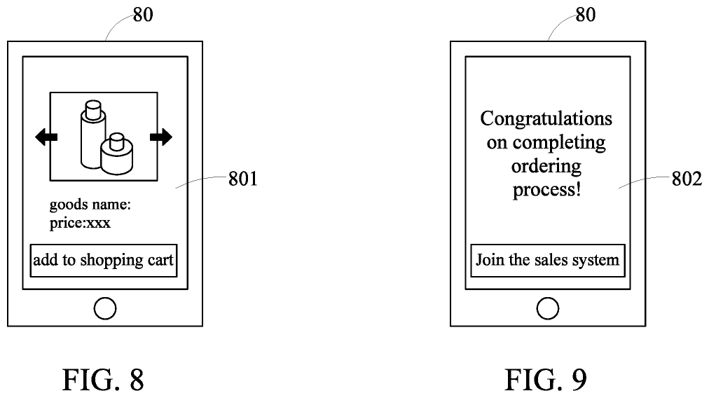

The multilevel structure sales system presents a cloud platform, on which terminal members can sell goods. A distributor software (APP) provided by the system can be installed on a related terminal device and serves as a portal of the sales node. Each node in the sales system is run as a sales node. FIG. 8 and FIG. 9 show some graphic user interfaces after the software program is started.

FIG. 8 is a schematic diagram illustrating a picture of sales software run on a terminal device. FIG. 8 shows a terminal device 80, for example, a mobile device or a personal computer, which presents a goods sales page 801. On the page, a user interface of selling and browsing goods is displayed. The name, price, and other information are presented below the goods, and an ordering function is also provided.

FIG. 9 is another schematic diagram. When a consumer purchases goods through a software interface of a sales node, after a deal is made, the terminal device 80 presents a sales system joining page 802, to provide the consumer with some information about joining in the sales system and guide the consumer to join in.

In the profit-sharing rules of the system, the multilevel structure sales system sets a “one-to-M” sales system, where M is a fixed value and is generally 3 in the above embodiment. The vertical number of levels is N, where

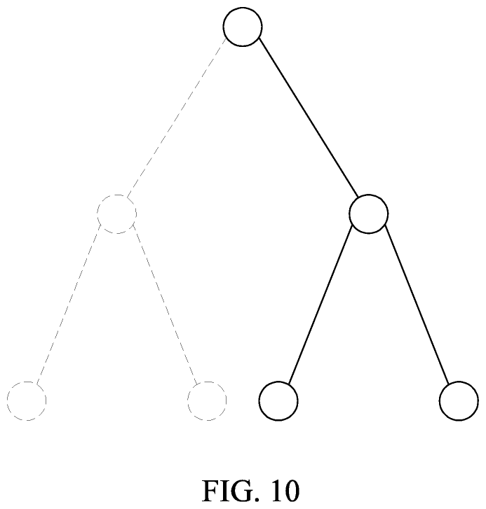

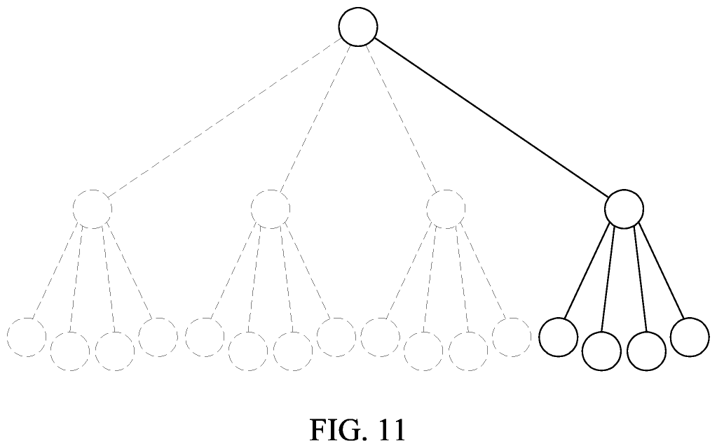

N is also a fixed value and is 10 in the above embodiment and any node beyond this range does not participate in profit sharing. However, M and N can be changed according to practical operation, for example, FIG. 10 shows that a link limit (horizontal link relationship) is 2; and FIG. 11 shows that a link limit is 4 in this embodiment.

In view of the above, the specification discloses a method for operating a multilevel structure sales system, in which a server uses software in a computer system to set link relationships between nodes and set number limits. The server also sets how to allocate new nodes. Therefore, the participating members can earn credits from profit gained by the lower level nodes under the rules. In this way, a novel sales system is established through a computer system.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for operating a multilevel structure sales system, comprising:
when one of the nodes of the sales system generates profit, judging whether all the upper level nodes linked to the profiting node within a level limit are eligible to obtain credits; and
obtaining the credits according to a ratio by any eligible upper level node linked to the profiting node within the level limit; and failing to obtain the credits by any ineligible upper level node of the profiting node,
wherein in the multilevel structure sales system, the number of nodes in a next level of a node is limited to a link limit; and each node earns the credits from the profit gained by its lower level nodes within the level limit.

2. The method for operating a multilevel structure sales system according to claim 1, wherein when a user becomes a member of the multilevel structure sales system, a new node of the sales system is established, the method comprising:
establishing a link relationship between the new node and an upper level node, the new node becoming one of the nodes in a next level of the upper level node within the link limit; and
recording, by the server, the link relationship between the new node and the upper level node, and updating the multilevel structure of the sales system.

3. The method for operating a multilevel structure sales system according to claim 1, wherein the method is performed in a server, and when one of the nodes of the sales system generates profit, the server utilizes one or more processors to run a credit processing program of the sales system, the program comprising starting calculation of the credits earned by the upper level nodes linked to the profiting node within the level limit.

4. The method for operating a multilevel structure sales system according to claim 3, wherein when the steps of the method are repeatedly performed, it is judged whether the upper level node has reached the level limit, and if yes, the credit processing program is terminated.

5. The method for operating a multilevel structure sales system according to claim 4, wherein when one of the upper level nodes of the profiting node is ineligible to obtain the credits, the other upper level nodes are still capable of obtaining the credits if they are eligible to obtain the credits.

6. The method for operating a multilevel structure sales system according to claim 5, wherein when a user becomes a member of the multilevel structure sales system, a new node of the sales system is established, the method comprising:
establishing a link relationship between the new node and an upper level node, the new node becoming one of the nodes in a next level of the upper level node within the link limit; and
recording, by the server, the link relationship between the new node and the upper level node, and updating the multilevel structure of the sales system.

7. The method for operating a multilevel structure sales system according to claim 1, wherein each node in the multilevel structure sales system is a sales node that sells goods in an online store or a physical store.

8. The method for operating a multilevel structure sales system according to claim 7, wherein the multilevel structure sales system presents a cloud platform, on which terminal members are capable of selling goods, distributor software being adopted as a portal of the sales node.

9. The method for operating a multilevel structure sales system according to claim 8, wherein when a user becomes a member of the multilevel structure sales system, a new node of the sales system is established, the method comprising:
establishing a link relationship between the new node and an upper level node, the new node becoming one of the nodes in a next level of the upper level node within the link limit; and
recording, by the server, the link relationship between the new node and the upper level node, and updating the multilevel structure of the sales system.

10. The method for operating a multilevel structure sales system according to claim 9, wherein the new node and its upper level node are each provided with an identifier (ID), and the ID is recorded in a database of the server according to the link relationship.

11. The method for operating a multilevel structure sales system according to claim 10, wherein the multilevel structure sales system is linked to a community system, and the members of the multilevel structure sales system establish a community relationship and share information through the community system.

12. The method for operating a multilevel structure sales system according to claim 10, wherein the multilevel structure sales system is linked to a communication system, and the members of the multilevel structure sales system transfer information through the communication system in the form of characters, pictures, or audio and video content.
